(19) United States
(12) Patent Application Publication
(10) Pub. No.: US 2025/0104402 A1
(43) Pub. Date: Mar. 27, 2025

(54) DEVICE AND METHOD FOR TRAINING MODEL FOR HUMAN IDENTIFICATION

(71) Applicants: Hyundai Motor Company, Seoul (KR); Kia Corporation, Seoul (KR); UIF (University Industry Foundation), Yonsei University, Seoul (KR)

(72) Inventors: Yongsang Yoon, Gwacheon-si (KR); Younghoon Shin, Seoul (KR); Bum Sub Ham, Seoul (KR); Sang Hoon Lee, Seoul (KR); Geon Lee, Seoul (KR)

(21) Appl. No.: 18/884,397

(22) Filed: Sep. 13, 2024

(30) Foreign Application Priority Data
Sep. 27, 2023 (KR) 10-2023-0130814

(51) Int. Cl. G06V 10/774; G06V 10/12; G06V 10/74; G06V 10/762; G06V 40/10

(52) U.S. Cl. CPC G06V 10/774; G06V 10/12; G06V 10/761; G06V 10/762; G06V 40/10

(57) ABSTRACT

A device, and method thereof, for training a model for human identification are provided may include a primary training module configured to primarily train the model with respect to a pre-prepared source dataset, a target subset generation module configured to generate a target subset by selecting some cameras from among a plurality of cameras included on a service robot, a feature vector extraction module configured to extract feature vectors of the target subset by using the model, a labeling module configured to perform labeling on the feature vectors, and a secondary training module configured to secondarily train the model with respect to a target dataset by using results of the labeling.

### CROSS-REFERENCE TO RELATED APPLICATIONS

This application claims priority to and the benefit of Korean Patent Application No. 10-2023-0130814 filed in the Korean Intellectual Property Office on Sep. 27, 2023, the entire contents of which are incorporated herein by reference.

### TECHNICAL FIELD

The disclosure relates to a device and method for training a model for human identification.

### BACKGROUND

Service robots are robots designed to perform specific tasks or provide services, which are distinct from industrial robots used in factories and may be used in a variety of fields. For example, service robots may include household robots that provide various services such as cleaning at home, medical service robots that help patients with their treatment in the medical field, serving robots that serve food, guidance and consultation robots that guide visitors or provide information, security robots that are responsible for specific areas or building security, support robots that support the daily life of the disabled or the elderly, etc. Service robots autonomously operate without direct control of human, but interaction with a human is often important, and it is often necessary to detect and locate the human.

To this end, a multi-camera system may be adopted in service robots. The multi-camera system may allow service robots to recognize an environment in three dimensions and recognize a human at various angles. In particular, the multi-camera system may also recognize areas that may not be recognized with a single camera, and integrate and process multiple data collected from multiple cameras, and thus, recognition accuracy may be improved, and recognize the environment and human in three dimensions, and thus, more accurate locating and interaction may be possible. However, although the multi-camera system improves the human recognition ability of service robots, an efficient algorithm is required as the amount of data to be processed increases and the amount of computation increases. In addition, in the multi-camera system, human re-identification (ReID), which recognizes the human detected in the field of view of one camera again in the field of view of another camera, is indispensable.

### SUMMARY

The disclosure relates to a device and method for training a model for human identification.

Some embodiments of the present disclosure can provide a device and method for training a model for human identification capable of improving the human recognition and re-identification performance of a service robot equipped with a multi-camera system.

A device for training a model for human identification according to an embodiment may include: one or more processors; and a storage medium storing computer-readable instructions that, when executed by the one or more processors, enable the one or more processors to provide: a primary training module configured to primarily train the model with respect to a pre-prepared source dataset, a target subset generation module configured to generate a target subset by selecting some cameras from among a plurality of cameras mounted on a service robot, a feature vector extraction module configured to extract feature vectors of the target subset by using the model, a labeling module configured to perform labeling on the feature vectors, and a secondary training module configured to secondarily train the model with respect to a target dataset by using results of the labeling.

In some embodiments, the instructions further enable the one or more processors to have a feature vector clustering module configured to determine similarities of the feature vectors and cluster the feature vectors according to the similarities.

In some embodiments, the feature vector clustering module may further cluster the feature vectors by using a Density-Based Spatial Clustering of Applications with Noise (DBSCAN) technique.

In some embodiments, the labeling module may further perform pseudo-labeling for each cluster clustered by the feature vector clustering module.

In some embodiments, the instructions further enable the one or more processors to have a weight assigning module configured to assign a weight for each cluster clustered by the feature vector clustering module.

In some embodiments, the weight assigning module may further assign a relatively higher weight to a given cluster that is determined to have a relatively higher diversity.

In some embodiments, the secondary training module may further progressively perform training by increasing a reflection ratio of a given cluster to which a relatively higher weight is assigned.

In some embodiments, the instructions further enable the one or more processors to have a repetition module configured to repeat the target subset generation module, the feature vector extraction module, the feature vector clustering module, and the labeling module until selected, set, or set conditions are satisfied.

In some embodiments, the instructions further enable the one or more processors to have a curriculum sequence generation module configured to generate a curriculum sequence for training the model by using results of labeling repeatedly generated by the repetition module, and the secondary training module may further perform curriculum learning on the model according to the curriculum sequence.

In some embodiments, the target subset generation module may further generate the target subset by preferentially selecting a given camera producing values with a relatively smaller difference from the source dataset from among the plurality of cameras.

A method for training a model for human identification according to an embodiment may include primarily training the model with respect to a pre-prepared source dataset; generating a target subset by selecting some cameras from among a plurality of cameras included on a service robot; extracting feature vectors of the target subset by using the model; labeling the feature vectors; and secondly training the model with respect to the target subset by using results of the labeling.

In some embodiments, the method may further include determining similarities of the feature vectors, and clustering the feature vectors according to the similarities.

In some embodiments, the clustering of the feature vectors may include clustering the feature vectors by using a Density-Based Spatial Clustering of Applications with Noise (DBSCAN) technique.

In some embodiments, the labeling may include performing pseudo-labeling for each clustered cluster.

In some embodiments, the method may further include assigning a weight for each clustered cluster.

In some embodiments, the assigning of the weight may include assigning a relatively higher weight to a given cluster that is determined to have a relatively higher diversity.

In some embodiments, the secondly training may include progressively performing training by increasing a reflection ratio of a given cluster to which the relatively higher weight is assigned.

In some embodiments, the method may further include repeating the generating of the target subset, the extracting of the feature vectors, the clustering of the feature vectors, and the labeling until set conditions are satisfied.

In some embodiments, the method may further include generating a curriculum sequence for training the model by using results of the labeling repeatedly generated by the repeating, and the secondly training may include performing curriculum learning on the model according to the curriculum sequence.

In some embodiments, the generating of the target subset may include generating the target subset by preferentially selecting a given camera producing values with a relatively smallerer difference from the source dataset from among the plurality of cameras.

### BRIEF DESCRIPTION OF THE DRAWINGS

FIGS. 1 and 2 are diagrams showing a model training device for human identification according to an embodiment of the present disclosure.

FIG. 3 is a diagram showing a model training method for human identification according to an embodiment of the present disclosure.

FIGS. 4 and 5 are diagrams showing a model training device for human identification according to an embodiment of the present disclosure.

FIGS. 6 and 7 are diagrams showing a model training device for human identification according to an embodiment of the present disclosure.

FIG. 8 is a diagram for explaining a computing device according to an embodiment of the present disclosure.

### DETAILED DESCRIPTION OF ILLUSTRATIVE EMBODIMENTS

With reference to the attached drawings, example embodiments of the present disclosure will be described in detail below so that ordinary skilled in the art may easily implement the present disclosure. However, embodiments of the present disclosure may be implemented in many different forms and are not limited to the example embodiments described herein. To clearly explain the present disclosure in the drawings, parts irrelevant to the description can be omitted, and like reference numerals can designate like elements throughout the specification.

Throughout the specification and the claims, unless explicitly described to the contrary, the word “comprise”, and variations such as “comprises” or “comprising”, may be understood to imply the inclusion of stated elements but not the exclusion of any other elements. Terms including ordinal numbers such as “first”, “second”, etc. may be used to describe various elements, but the elements are not necessarily limited by such terms. Such terms can be used merely for the purpose of distinguishing one element from another element.

Terms such as “-portion”, “-group”, and “module” described in the specification may refer to a unit that processes at least one function or operation described in the specification, which may be implemented as hardware or software or a combination of hardware and software.

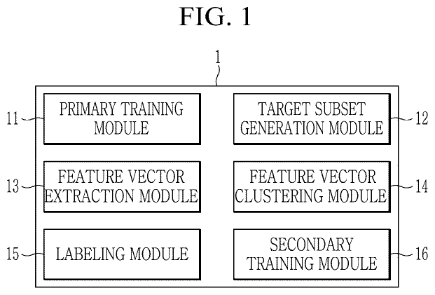

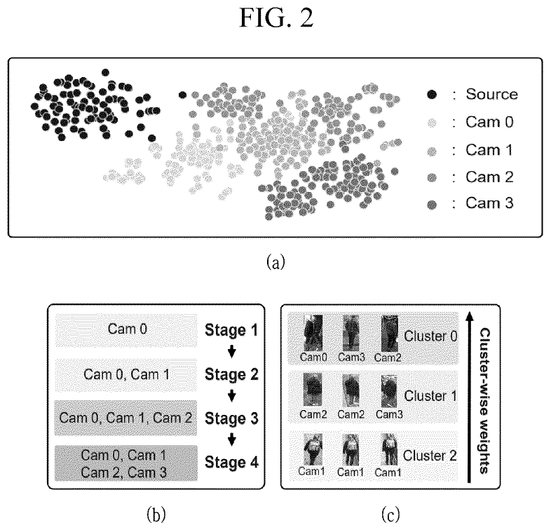

FIGS. 1 and 2 are diagrams showing a model training device for human identification according to an embodiment of the present disclosure.

Human recognition through a camera is a major technical factor in a service robot that has many continuous interactions with a human, and is drawing more attention with the development of computer vision and deep learning technology. Human recognition may include a variety of detailed techniques, such as facial recognition, which identifies an individual by analyzing facial features, posture and motion recognition, which recognizes and analyzes a posture or movement of human, person re-identification, which identifies the same individual in the field of view of multiple cameras, behavior recognition, which classifies or predicts the behavior of a human in a video sequence, person segmentation, which separates a human silhouette from an image or video, etc. The performance of such techniques is greatly dependent on learning data or a learning method, and thus, a learning technique for a model used for human recognition is important. The model training device 1 for human identification according to an embodiment may include a configuration described in various embodiments below to improve the human recognition and re-identification performance of a service robot equipped with a multi-camera system. Referring to FIG. 1, the model training device 1 for human identification may include a primary training module 11, a target subset generation module 12, a feature vector extraction module 13, a feature vector clustering module 14, a labeling module 15, and a secondary training module 16, any combination of or all of which may be in plural or may include plural components thereof.

The primary training module 11 may primarily train a model with respect to a pre-prepared source dataset. The model may be a model used to perform human recognition and re-identification of a service robot equipped with a multi-camera system. A source dataset can be data used to primarily train a model, and may generally be configured as data including large and diverse information. For example, a large image dataset, such as ImageNet, may be used as a source dataset. A model may learn relatively rich features by performing learning with respect to the source dataset. In other words, the primary training module 11 may also pre-train (or prior train) the model. Features learned from the source dataset may also be useful for an actual target task, that is, human recognition and re-identification tasks of a service robot equipped with a multi-camera system, and may allow for faster secondary learning with respect to a target dataset that is relatively small and task-specific information.

The target subset generation module 12 may generate a target subset by selecting some cameras from among a plurality of cameras included in the multi-camera mounted on the service robot. A target dataset can be data for using the model pre-trained by the primary training module 11 for the actual target task, such as human recognition and re-identification tasks of the service robot equipped with the multi-camera system, and the target subset may refer to a set of data indicating a specific part or category within the target dataset. In particular, the target subset in the specification may refer to an image set primarily obtained from a camera to ultimately generate a target dataset used by the secondary training module 16, which will be described below. The target subset may be determined as the target dataset used by the secondary training module 16 through subsequent operations, such as feature vector extraction and labeling, which will be described below.

When target subsets are simultaneously generated with respect to all the plurality of cameras included in the multi-camera system, it may be difficult to find generality due to high complexity, and when target subsets are generated with respect to all the cameras without considering a difference from a source dataset, learning performance may not be sufficient. On the other hand, when a target subset is generated with respect to a camera with a large difference from the source dataset, learning performance may also deteriorate. To solve such a performance problem, in some embodiments, the target subset generation module 12 may generate the target subset by preferentially selecting a camera with a smaller difference from the source dataset from among the plurality of cameras of the multi-camera system.

The multi-camera system may include a first camera Cam 0, a second camera Cam 1, a third camera Cam 2, and a fourth camera Cam 3. Referring to (a) of FIG. 2, feature vectors can be expressed in an embedding space, feature vectors named “Source” may indicate source datasets, feature vectors named “Cam 0”, “Cam 1”, and “Cam 2”, and “Cam 3” may indicate target datasets corresponding to the first camera Cam 0, the second camera Cam 1, the third camera Cam 2, and the fourth camera Cam 3, respectively. In the model training device 1 for human identification according to an embodiment, a domain shift may be performed from the source dataset “Source” to the target datasets “Cam 0”, “Cam 1”, “Cam 2”, and “Cam 3”, and when data corresponding to a camera with a less difference from the source dataset from among the first camera Cam 0, second camera Cam 1, third camera Cam 2, and fourth camera Cam 3 is preferentially selected as a target subset, the target dataset may also be configured as data that may train a model to ensure better or excellent learning performance.

In some embodiments, differences between the source dataset and the data from the camera to be generated as the target subset may be quantified by measuring distribution differences. For example, the target subset generation module 12 may measure a difference between a distribution of the source dataset and a distribution of the data of the camera to be generated as the target subset by using a Maximum Mean Discrepancy (MMD) technique, and, for example, may calculate the difference between the two distributions by comparing the means between samples of the two distributions. A specific calculation equation may include an equation that uses a distance between expectation values of the two distributions in a space expressed as a function of Reproducing Kernel Hilbert Space (RKHS), for example, but the scope of the present disclosure is not limited to a specific equation, and may include using various equations that may measure the difference between the two distributions. The target subset generation module 12 may calculate an MMD value for each of the first camera Cam 0, the second camera Cam 1, the third camera Cam 2, and the fourth camera Cam 3, and regard data corresponding to data of the camera with the smallest MMD value as data with the least difference from the source dataset, and preferentially select the data as the target subset. For example, the target subset generation module 12 may calculate a distribution difference between the source dataset and each of the first camera Cam 0, the second camera Cam 1, the third camera Cam 2, and the fourth camera Cam 3, and generate the target subset corresponding to the first camera Cam 0 with the least distribution difference as the target subset. Then, feature vector extraction and labeling may be performed on the generated target subset.

In some embodiments, target subset generation module 12 may repeat generating the target subset for progressive learning over several stages. Referring to (b) of FIG. 2, as a result of calculating the distribution difference between the source dataset and each of the first camera Cam 0, the second camera Cam 1, the third camera Cam 2, and the fourth camera Cam 3 in a first stage, the target subset generation module 12 may generate a first target subset corresponding to the first camera Cam 0 with the least distribution difference from the source dataset, and perform feature vector extraction and labeling on the generated first target subset. In a second stage following the first stage, the target subset generation module 12 may then generate a second target subset corresponding to the second camera Cam 1 with a small distribution difference from the source dataset and perform feature vector extraction and labeling on the first target subset and the generated second target subset. In a third stage following the second stage, the target subset generation module 12 may then generate a third target subset corresponding to the third camera Cam 2 with a small distribution difference from the source dataset and perform feature vector extraction and labeling on the first and second target subsets and the generated third target subset. In a fourth stage following the third stage, the target subset generation module 12 may generate a fourth target subset corresponding to the fourth camera Cam 3 with the greatest distribution difference from the source dataset and perform feature vector extraction and labeling on the first to third target subsets and the generated fourth target subset.

The feature vector extraction module 13 may extract feature vectors of the target subset generated by the target subset generation module 12 by using the model. The feature vector extraction module 13 may extract information representing data included in the target subset in the form of a vector. Extraction of feature vectors may be manually performed, but a deep learning method of directly learning features from data may also be used.

The feature vector clustering module 14 may determine similarities of the feature vectors extracted by the feature vector extraction module 13 and cluster the feature vectors according to the similarities. The feature vector clustering module 14 may cluster the feature vectors by using, for example, a Density-Based Spatial Clustering of Applications with Noise (DBSCAN) technique. DBSCAN is a density-based clustering algorithm that may operate on the principle of regarding high-density areas, that is, areas where data points are close together, as a cluster, and processing low-density areas by noise. When DBSCAN is applied to the feature vectors extracted by the feature vector extraction module 13, similar feature vectors can be located close to each other, and thus, these feature vectors may be clustered and regarded as one cluster.

For example, the feature vector clustering module 14 may set the maximum distance for including another feature vector from a feature vector and the minimum number of feature vectors that exist within the maximum distance with respect to a feature vector. The feature vector clustering module 14 may select a feature vector and generate a new cluster when feature vectors exceeding the minimum number exist within the maximum distance from the selected feature vector. In addition, the feature vector clustering module 14 may form a cluster based on the similarities between the feature vectors by repeating adding all neighboring feature vectors within the maximum distance from the selected feature vector to the cluster when the selected feature vector has more than the minimum number of neighboring feature vectors within the maximum distance, or adding the selected feature vector to the cluster when the selected feature vector is within the maximum distance but has fewer feature vectors than the minimum number.

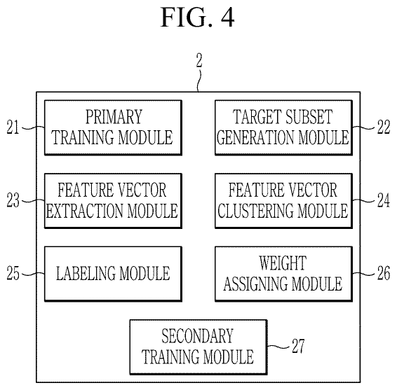

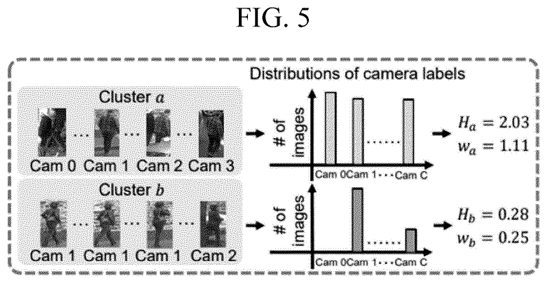

Referring to (c) of FIG. 2, the feature vector clustering module 14 may generate a first cluster “Cluster 0” originating from data corresponding to the first camera Cam 0, the second camera Cam 1, and the third camera Cam 2 and corresponding to a set of feature vectors estimated to be a human, a second cluster “Cluster 1” originating from data corresponding to the third camera Cam 2 and the fourth camera Cam 3 and corresponding to a set of feature vectors estimated to be another human, and a third cluster “Cluster 2” originating from data corresponding to the second camera Cam 1 and corresponding to a set of feature vectors estimated to be another human. The first camera Cam 0, the second camera Cam 1, the third camera Cam 2, and the fourth camera Cam 3 can be factors included in the multi-camera system of the service robot that photograph the same human at different positions and angles, and thus, the first cluster “Cluster 0” corresponding to the first camera Cam 0, the second camera Cam 1, and the third camera Cam 2 may have the highest diversity, the second cluster “Cluster 1” corresponding to the third camera Cam 2 and the fourth camera Cam 3 may have the next highest diversity, and the third cluster “Cluster 2” corresponding only to the second camera Cam 1 may have the lowest diversity. In other words, the first cluster “Cluster 0” includes a variety of backgrounds, postures, and costumes and may be as having relatively much content to learn, and the third cluster “Cluster 2” is highly likely to include the same backgrounds, postures, and costumes and may be as having relatively little content to learn. With regard to training of the model for human identification, the diversity of such clusters may be additionally considered, and this will be described below with reference to FIGS. 4 and 5.

The labeling module 15 may perform pseudo-labeling for each feature vector extracted by the feature vector extraction module 13 or for each cluster clustered by the feature vector clustering module 14. Pseudo-labeling can be assigning a label predicted by the model to unlabeled data as a “pseudo-label”, and pseudo-labeled data generated as above may be optionally used for model training together with the original labeled data.

The secondary training module 16 may secondarily train the model with respect to the target dataset by using results of labeling performed by the labeling module 15.

As described above, as a dataset designed to maximize the training effect by considering detailed characteristics of the data obtained from the plurality of cameras included in the multi-camera system of the service robot, by applying the training technique described above, excellent training effects may be expected while reducing the enormous calculation time and cost that may occur in unsupervised domain adaptation. In addition, the human recognition and re-identification performance of the mounted service robot may be improved. In particular, as an example implementation, when the model trained according to an embodiment of the present disclosure is used as the dataset of Market-1501 and DukeMTMC, and mean average precision (mAP) and Rank-1 accuracy are used as evaluation indicators, a performance improvement effect of about 30% p (percentage point) has been obtained as follows.

TABLE 1

| | | | Present |
|---|---|---|---|
| | Evaluation | Existing | disclosure |
| Dataset | indicators | method | method |
| Market-1501 | mAP | 32.4% | 67.5% |
| | Rank-1 | 51.1% | 80.5% |
| DukeMTMC | mAP | 32.3% | 78.1% |
| | Rank-1 | 63.9% | 92.0% |

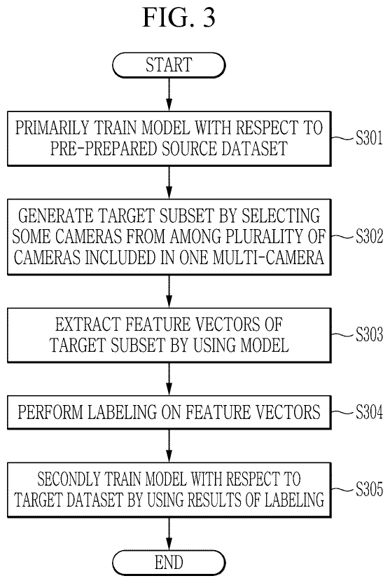

FIG. 3 is a diagram showing a model training method for human identification according to an embodiment of the present disclosure.

Referring to FIG. 3, a model training method for human identification according to an embodiment may include: primarily training a model with respect to a pre-prepared source dataset (operation S301); generating a target subset by selecting some cameras from among a plurality of cameras included in a multi-camera mounted on a service robot (operation S302); extracting feature vectors of the target subset by using the model (operation S303); performing labeling on the feature vectors (operation S304); and secondly training the model with respect to the target dataset by using results of labeling (operation S305). For more detailed information about the example method of FIG. 3, the description of the embodiments described in the specification with reference to FIGS. 1 to 2 and 4 to 8 may be referenced or applied, and thus, redundant description thereof can be omitted here. For example, the method embodiment described in FIG. 3 may be implemented using example embodiments of FIGS. 1 to 2 and 4 to 8.

FIGS. 4 and 5 are diagrams showing a model training device for human identification according to an embodiment of the present disclosure.

Referring to FIG. 4, a model training device 2 for human identification according to an embodiment may include a primary training module 21, a target subset generation module 22, a feature vector extraction module 23, a feature vector clustering module 24, a labeling module 25, a weight assigning module 26, and a secondary training module 27, any combination of or all of which may be in plural or may include plural components thereof. For the primary training module 21, the target subset generation module 22, the feature vector extraction module 23, the feature vector clustering module 24, the labeling module 25, and the secondary training module 27, to the extent not contradictory, the descriptions of the primary training module 11, the target subset generation module 12, the feature vector extraction module 13, the feature vector clustering module 14, the labeling module 15, and the secondary training module 16 given above with reference to FIG. 1 may be referenced or applied, and thus, the weight assigning module 26 will be mainly described while referring to FIGS. 4 and 5.

The weight assigning module 26 may assign a weight for each cluster clustered by the feature vector clustering module 24. Specifically, the weight assigning module 26 may assign a high weight to a cluster that is determined to have a high diversity. The secondary training module 27 may progressively perform training by increasing a reflection ratio of the cluster to which the higher weight is assigned.

Referring to FIG. 5 together, the feature vector clustering module 24 may generate a first cluster “Cluster a” originating from data corresponding to the first camera Cam 0, the second camera Cam 1, the third camera Cam 2, and the fourth camera Cam 3 and corresponding to a set of feature vectors estimated to be a human, and a second cluster “Cluster b” originating from data corresponding to the second camera Cam 1 and the third camera Cam 2 and corresponding to a set of feature vectors estimated to be another human. The first camera Cam 0, the second camera Cam 1, the third camera Cam 2, and the fourth camera Cam 3 can be factors included in the multi-camera system of the service robot that photograph the same human at different positions and angles, and thus, a diversity of the first cluster “Cluster a” corresponding to the first camera Cam 0, the second camera Cam 1, the third camera Cam 2, and the fourth camera Cam 3 may be higher than a diversity of the second cluster “Cluster b” corresponding to the second camera Cam 1 and the third camera Cam 2. In other words, for this example, the first cluster “Cluster a” includes more diverse backgrounds, postures, and costumes than the second cluster “Cluster b” and may be as having relatively more content to learn.

The weight assigning module 26 may assign a relatively higher weight (e.g., wₐ=1.11) to the first cluster “Cluster a” and a relatively lower weight (e.g., w_{b}=0.25) to the second cluster “Cluster b”, and the second training module 27 may progressively perform training by increasing a reflection ratio of the first cluster “Cluster a” to which relatively higher weight is assigned compared to the second cluster “Cluster b”. Accordingly, with regard to training of the model for human identification, model training can be performed mainly based on data having more content to learn, and thus, better or excellent training effects may be expected while training can be possible with a smaller amount of data.

In some embodiments, the weight assigning module 26 may calculate a weight from an entropy value of an information theory, for example. Entropy of the information theory may be used to measure the uncertainty of a random variable, and may be calculated by considering the probability of a possible event and an amount of information of the corresponding event. A weight may be calculated according to a selected, set, or predetermined equation from the entropy value. In a simple method, for example, the weight may be calculated by dividing an entropy value of each of the first cluster “Cluster a” and the second cluster “Cluster b” by entropy values of all clusters. For example, the weight wₐ may be calculated by dividing an entropy value Hₐ=2.03 of the first cluster “Cluster a” by the entropy values of all clusters, and the weight we may be calculated by dividing an entropy value H_{b}=0.28 of the second cluster “Cluster b” by the entropy values of all clusters. A method of calculating a weight by using an entropy value is not limited to the example method described above.

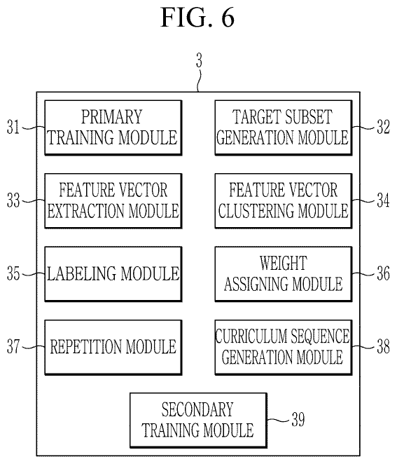

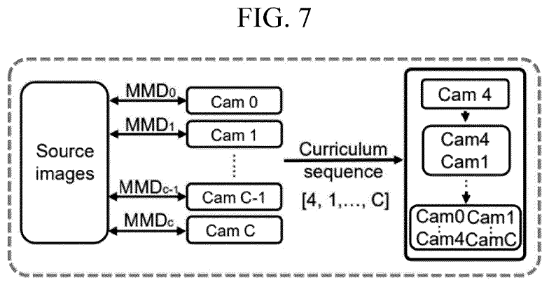

FIGS. 6 and 7 are diagrams showing a model training device for human identification according to an embodiment of the present disclosure.

Referring to FIG. 6, a model training device 3 for human identification according to an embodiment may include a primary training module 31, a target subset generation module 32, a feature vector extraction module 33, a feature vector clustering module 34, a labeling module 35, a weight assigning module 36, a repetition module 37, a curriculum sequence generation module 38, and a secondary training module 39, any combination of or all of which may be in plural or may include plural components thereof. For the primary training module 31, the target subset generation module 32, the feature vector extraction module 33, the feature vector clustering module 34, the labeling module 35, the weight assigning module 36, and the secondary training module 39, to the extent not contradictory, the descriptions of the primary training modules 11 and 21, the target subset generation modules 12 and 22, the feature vector extraction modules 13 and 23, the feature vector clustering modules 14 and 24, the labeling modules 15 and 25, the weight assigning module 26, and the secondary training modules 16 and 27 given above with reference to FIGS. 1 and 4 may be referenced or applied, and thus, the repetition module 37 and the curriculum sequence generation module 38 will be mainly described while referring to FIGS. 6 and 7.

The repetition module 37 may repeat the target subset generation module 32, the feature vector extraction module 33, the feature vector clustering module 34, and the labeling module 35 until selected, set, or predetermined conditions are satisfied. In addition, the curriculum sequence generation module 38 may generate a curriculum sequence for training a model by using results of labeling repeatedly generated by the repetition module 37. The secondary training module 39 may perform curriculum learning on the model according to the curriculum sequence. Curriculum learning can be an artificial intelligence learning strategy for solving complex problems, and may refer to a technique that starts with simple problems and gradually moves to more difficult problems. In particular, curriculum learning in the example embodiment may refer to starting learning with data with a high similarity to a source dataset and gradually proceeding with learning with more complex and generalized data when learning is stabilized.

Referring also to FIG. 7, the repetition module 37 may repeat generating a target subset for progressive training. In a first repetition, as a result of calculating distribution differences between a source dataset and each of a plurality of cameras Cam 0 to Cam C (C being a non-negative integer), the target subset generation module 32 may generate a first target subset corresponding to a camera Cam 4 with the least distribution difference from the source dataset, in this example, and results labeled by the feature vector extraction module 33, the feature vector clustering module 34, and the labeling module 35 may be added to the curriculum sequence. Next, in a second repetition, the target subset generation module 32 may generate a second target subset corresponding to the camera Cam 1 with a relatively smaller distribution difference from the source dataset, in this example, and results labeled by the feature vector extraction module 33, the feature vector clustering module 34, and the labeling module 35 may be added to the curriculum sequence. Next, in a third repetition, the target subset generation module 32 may then generate a third target subset corresponding to the camera Cam 0 with a relatively smaller distribution difference from the source dataset, in this example, and results labeled by the feature vector extraction module 33, the feature vector clustering module 34, and the labeling module 35 may be added to the curriculum sequence. Finally, in an nth repetition (n is a natural number), the target subset generation module 32 may generate nth target subset corresponding to the camera Cam C with the relatively greatest distribution difference from the source dataset, and results labeled by the feature vector extraction module 33, the feature vector clustering module 34, and the labeling module 35 may be added to the curriculum sequence. The secondary training module 39 may perform curriculum learning on the model according to the curriculum sequence generated based on the first to nth target subsets.

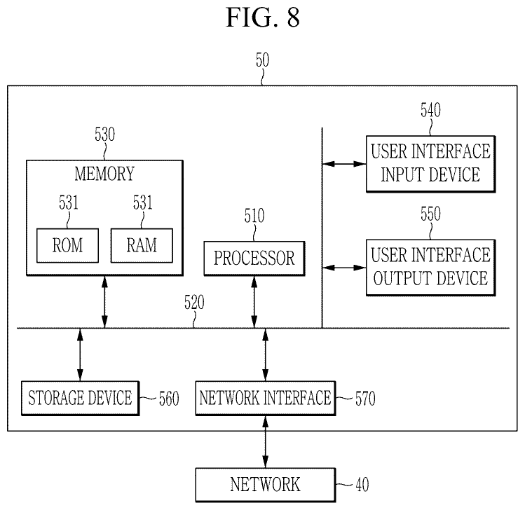

FIG. 8 is a diagram for explaining a computing device according to an embodiment of the present disclosure.

Referring to FIG. 8, an example model training device and method for human identification according to example embodiments may be implemented by using a computing device 50.

The computing device 50 may include at least one of a processor 510, a memory 530, a user interface input device 540, a user interface output device 550, and a storage device 560 that communicate via a bus 520, any combination of or all of which may be in plural or may include plural components thereof. The computing device 50 may also include a network interface 570 that is electrically connected to a network 40. The network interface 570 may transmit or receive signals to and from other entities over the network 40.

The processor 510 may be implemented as various types, such as a Micro Controller Unit (MCU), Application Processor (AP), Central Processing Unit (CPU), Graphic Processing Unit (GPU), Neural Processing Unit (NPU), and Quantum Processing Unit (QPU) and may be any semiconductor device that executes commands stored in the memory 530 or the storage device 560. The processor 510 may be configured to implement the functions and methods described above with respect to FIGS. 1 to 7.

A storage medium can include the memory 530 and the storage device 560, which may include various types of volatile or non-volatile storage media. For example, the memory 530 may include read-only memory (ROM) 531 and random access memory (RAM) 532. In the embodiment, the memory 530 may be located inside or outside the processor 510, and the memory 530 may be connected to the processor 510 through various known implementations.

In some embodiments, at least some components or functions of the model training device and method for human identification according to the example embodiments may be implemented as a program or software running on the computing device 50, and the program or software may be stored on a computer-readable medium. Specifically, the computer-readable medium according to an embodiment can be a computer including the processor 510 that executes a program or command stored in the memory 530 or the storage device 560, and may record thereon a program for executing steps included in the model training device and method for human identification according to embodiments.

In some embodiments, at least some components or functions of the model training device and method for human identification according to the example embodiments may be implemented by using hardware or circuit of the computing device 50, or may also be implemented as separate hardware or circuit that may be electrically connected to the computing device 50.

According to the example embodiments described above, as a dataset designed to maximize the training effect by considering detailed characteristics of data obtained from a plurality of cameras included in a multi-camera system of a service robot, by applying the training technique described above, better or excellent training effects may be expected while reducing the enormous calculation time and cost that may occur in unsupervised domain adaptation. In addition, using an embodiment of the present disclosure, the human recognition and re-identification performance of the mounted service robot may be improved.

Although example embodiments of the present disclosure have been described in detail above, scopes of the present disclosure are not limited thereto, and various modifications and improvements, including equivalents thereof, made by those of ordinary skill in the field to which the present disclosure pertains also can belong to the scopes of the present disclosure.

What is claimed is:

1. A device for training a model for human identification, the device comprising:
one or more processors; and
a storage medium storing computer-readable instructions that, when executed by the one or more processors, enable the one or more processors to provide:
a primary training module configured to primarily train the model with respect to a pre-prepared source dataset,
a target subset generation module configured to generate a target subset by selecting some cameras from among a plurality of cameras mounted on a service robot,
a feature vector extraction module configured to extract feature vectors of the target subset by using the model,
a labeling module configured to perform labeling on the feature vectors, and
a secondary training module configured to secondarily train the model with respect to a target dataset by using results of the labeling.

2. The device of claim 1, wherein the instructions further enable the one or more processors to have a feature vector clustering module configured to determine similarities of the feature vectors and cluster the feature vectors according to the similarities.

3. The device of claim 2, wherein the feature vector clustering module is further configured to cluster the feature vectors by using a Density-Based Spatial Clustering of Applications with Noise (DBSCAN) technique.

4. The device of claim 2, wherein the labeling module is further configured to perform pseudo-labeling for each cluster clustered by the feature vector clustering module.

5. The device of claim 2, wherein the instructions further enable the one or more processors to have a weight assigning module configured to assign a weight for each cluster clustered by the feature vector clustering module.

6. The device of claim 5, wherein the weight assigning module is further configured to assign a relatively higher weight to a given cluster that is determined to have a relatively higher diversity.

7. The device of claim 5, wherein the secondary training module is further configured to progressively perform training by increasing a reflection ratio of a given cluster to which a relatively higher weight is assigned.

8. The device of claim 2, wherein the instructions further enable the one or more processors to have a repetition module configured to repeat the target subset generation module, the feature vector extraction module, the feature vector clustering module, and the labeling module until set conditions are satisfied.

9. The device of claim 8, wherein the instructions further enable the one or more processors to have a curriculum sequence generation module configured to generate a curriculum sequence for training the model by using results of labeling repeatedly generated by the repetition module, and
wherein the secondary training module is further configured to perform curriculum learning on the model according to the curriculum sequence.

10. The device of claim 1, wherein the target subset generation module is further configured to generate the target subset by preferentially selecting a given camera producing values with a relatively smaller difference from the source dataset from among the plurality of cameras.

11. A method for training a model for human identification, the method comprising:
primarily training the model with respect to a pre-prepared source dataset;
generating a target subset by selecting some cameras from among a plurality of cameras included on a service robot;
extracting feature vectors of the target subset by using the model;
labeling the feature vectors; and
secondly training the model with respect to the target subset by using results of the labeling.

12. The method of claim 11, further comprising:
determining similarities of the feature vectors; and
clustering the feature vectors according to the similarities.

13. The method of claim 12, wherein the clustering of the feature vectors comprises clustering the feature vectors by using a Density-Based Spatial Clustering of Applications with Noise (DBSCAN) technique.

14. The method of claim 12, wherein the labeling comprises performing pseudo-labeling for each clustered cluster.

15. The method of claim 12, further comprising assigning a weight for each clustered cluster.

16. The method of claim 15, wherein the assigning of the weight comprises assigning a relatively higher weight to a given cluster that is determined to have a relatively higher diversity.

17. The method of claim 15, wherein the secondly training comprises progressively performing training by increasing a reflection ratio of a given cluster to which a relatively higher weight is assigned.

18. The method of claim 12, further comprising repeating the generating of the target subset, the extracting of the feature vectors, the clustering of the feature vectors, and the labeling until set conditions are satisfied.

19. The method of claim 18, further comprising generating a curriculum sequence for training the model by using results of the labeling repeatedly generated by the repeating, and wherein the secondly training comprises performing curriculum learning on the model according to the curriculum sequence.

20. The method of claim 11, wherein the generating of the target subset comprises generating the target subset by preferentially selecting a given camera producing values with a relatively smaller difference from the source dataset from among the plurality of cameras.
